(19) United States
(12) Patent Application Publication
(10) Pub. No.: US 2012/0141094 A1
(43) Pub. Date: Jun. 7, 2012

(54) METHOD FOR GENERATING TRAINING VIDEO AND RECOGNIZING SITUATION USING COMPOSED VIDEO AND APPARATUS THEREOF

(75) Inventors: Sahngwon RYOO, Daejeon (KR); Won Pil YU, Ulsan (KR)

(73) Assignee: Electronics and Telecommunications Research Institute, Daejeon (KR)

(21) Appl. No.: 13/309,963

(22) Filed: Dec. 2, 2011

(30) Foreign Application Priority Data
Dec. 2, 2010 (KR) 10-2010-0122188

(51) Int. Cl. H04N 5/93

(52) U.S. Cl. 386/278; 386/E05.003

(57) ABSTRACT

Disclosed are a method and an apparatus for generating training videos and recognizing situations, using composed videos. The method for generating training videos using composed videos according to an exemplary embodiment of the present invention includes generating composed videos based on configuration information of an original video; selecting the composed videos satisfying structural constraints of situations among the generated composed videos; and configuring the training videos including the selected composed videos.

### CROSS-REFERENCE TO RELATED APPLICATIONS

This application claims priority to and the benefit of Korean Patent Application NO. 10-2010-0122188 filed in the Korean Intellectual Property Office on Dec. 2, 2010, the entire contents of which are incorporated herein by reference.

### TECHNICAL FIELD

The present invention relates to a method and an apparatus for generating training videos and recognizing situations using composed videos.

### BACKGROUND

Recently, technologies for recognizing dynamic situations have been actively discussed. Herein, recognizing the dynamic situations may include a case of recognizing situations of human activities or a case of recognizing motions of objects. These technologies have been used for monitoring/security/surveillance or a method for recognizing dangerous situations due to traveling of vehicles, by using videos input through a video collection apparatus such as CCTV, and the like.

In particular, since humans are a subject of various activities, it is difficult to recognize situations of each activity. Human activity recognition is a technology of automatically detecting human activities observed from given videos.

The human activity recognition is applied to monitoring/security/surveillance using multiple cameras, dangerous situation detection using dynamic cameras, or the like. At present, most of the human activity recognition methods requires training videos for human activity to be recognized and teaches a recognition system using the training videos. When new videos are input, the above-mentioned methods according to the related art analyze the videos and detect the activities, on the basis of the learning results. In particular, the methods according to the related art use real videos photographed by cameras for use as training videos for recognizing human activities. However, the methods need to devote a lot of efforts to collect real videos. In particular, in case of rare events (for example, stealing products), the methods need to obtain various types of training videos, which is extremely difficult in reality.

### SUMMARY

The present invention has been made in an effort to solve problems requiring numerous real photographing videos so as to obtain training videos and more effectively recognize situations using the videos in the related art.

An exemplary embodiment of the present invention provides a method for generating training videos using composed videos, including: generating composed videos based on configuration information of an original video; selecting the composed videos satisfying structural constraints of situations among the generated composed videos; and configuring the training videos including the selected composed videos.

Another exemplary embodiment of the present invention provides a method for recognizing situations using composed videos, including: generating composed videos based on configuration information of an original video; selecting the composed videos satisfying structural constraints of situations among the generated composed videos; configuring the training videos including the selected composed videos; and recognizing situations of recognition object videos based on the training videos.

Yet another exemplary embodiment of the present invention provides an apparatus for generating training videos using composed videos, including: a composed video, generation unit that generates composed videos based on configuration information of an original video; a composed video selection unit that selects the composed videos satisfying structural constraints of situations among the generated composed videos; and a training video configuration unit that configures the training videos including the selected composed videos.

Still another exemplary embodiment of the present invention provides an apparatus for recognizing situations using composed videos, including: a composed video generation unit that generates composed videos based on configuration information of an original video; a composed video selection unit that selects the composed videos satisfying structural constraints of situations among the generated composed videos; a training video configuration unit that configures the training videos including the selected composed videos; and a situation recognition unit that recognizes situations of a recognition object video based on the training videos.

According to exemplary embodiments of the present invention, it is possible to save efforts, time, and costs to obtain the numerous real photographing videos so as to generate the training videos, thereby effectively increasing the efficiency of the situation recognition.

### BRIEF DESCRIPTION OF THE DRAWINGS

FIG. 1 is a diagram for explaining a concept of an exemplary embodiment of the present invention.

FIG. 2 is a diagram for explaining composed videos according to an exemplary embodiment of the present invention.

FIG. 3 is a diagram showing a process of composing videos according to an exemplary embodiment of the present invention.

FIG. 4 is a diagram for explaining a method for generating training videos and a method for recognizing situations using composed videos according to an exemplary embodiment of the present invention.

FIG. 5 is a diagram for explaining an apparatus for generating training videos using composed videos and an apparatus for recognizing situations using composed videos according to an exemplary embodiment of the present invention.

FIG. 6 is a diagram for explaining an example of analyzing videos (original video) for “pushing”.

FIG. 7 is a diagram for explaining a process of generating composed videos.

FIG. 8 is a diagram for explaining a model for setting structural constraints.

FIG. 9 is a diagram showing an iteration algorithm for improving accuracy of a decision boundary.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

The specific terms used in the following description are provided in order to help understanding of the present invention. The use of the specific terms may be changed into other forms without departing from the technical idea of the present invention.

Meanwhile, the exemplary embodiments according to the present invention may be implemented in the form of program instructions that can be executed by computers, and may be recorded in computer readable Media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. Hereinafter, exemplary embodiments of the present invention will be described in detail with reference to the accompanying drawings.

An exemplary embodiment of the present invention generates a plurality of training videos used to achieve predetermined purposes. The training videos include composed videos artificially composed based on really photographed videos (original videos). In this case, the original videos may include real videos and animation including 3D and the composed videos may be generated as virtual videos like animation including 3D.

The composed video may be manufactured by reconfiguring background/motion/size/color, or the like, of the original video in various aspects. Meanwhile, the exemplary embodiment of the present invention may generate the composed videos by adding original additional video elements so as to generate the composed videos having much diversity. For example, the background of the original videos may be replaced by other background videos.

Hereinafter, the generation of the composed videos for videos including human activity will be mainly described. However, the idea of the exemplary embodiment of the present invention is not limited to human activity and may also be applied to the generation of the composed videos for videos including motions of objects.

The exemplary embodiment of the present invention also discloses a technology of recognizing situations using the composed videos artificially composed. When the exemplary embodiment of the present invention is applied to recognize human activity, the exemplary embodiment of the present invention recognizes the situations by comparing the videos collected through the video collection apparatus such as CCTV, or the like with the training videos configured of the pre-composed videos, or the like, which may be applied to the monitoring/security/surveillance. Meanwhile, the exemplary embodiment of the present invention may be applied to a field of recognizing dangerous situations during traveling of vehicles or recognizing abnormal situations of passengers or loadings when the exemplary embodiment of the present invention is applied to recognize motions of objects.

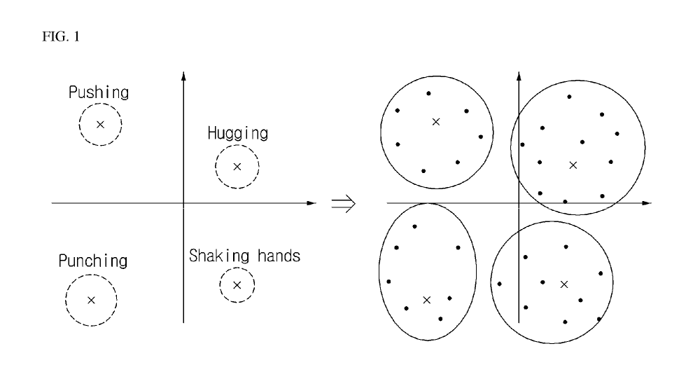

FIG. 1 is a diagram for explaining a concept of an exemplary embodiment of the present invention.

The left coordinates of FIG. 1 show a sort of interaction of two persons using hands or arms. 1-quadrant is sorted into hugging, 2-quadrant is sorted into pushing, 3-quadrant is sorted into punching, and 4-quadrant is sorted into shaking hands. An (X) mark represents one original video for each activity and a dotted line represents a range of recognizable situations when using only each original video as a training video. Since the training video (herein, meaning the original video itself) is one, a range of recognizable situations is not large like the dotted line. The right coordinates of FIG. 1 show expanding a range of recognizable situations like a solid line by being added to the original video (X) on the left coordinates of FIG. 1 to generate a plurality of composed videos (dots marked in the solid range of the right coordinates of FIG. 1) and using the composed videos as training videos. By this, the exemplary embodiment of the present invention solves ambiguity of the situation recognition range like a dotted line of the left coordinates of FIG. 1, thereby enabling reliable human activity recognition.

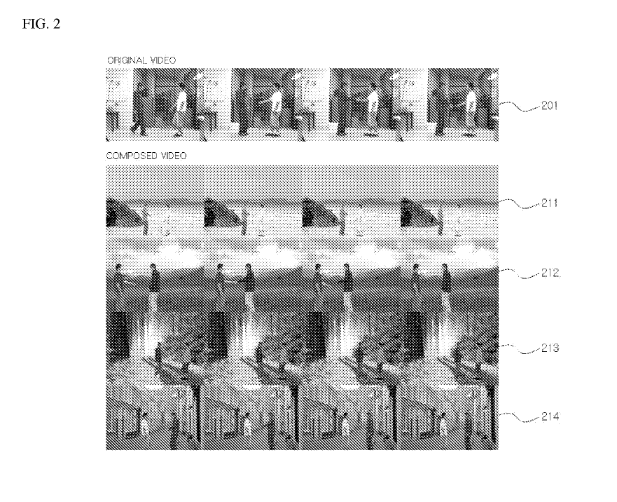

FIG. 2 is a diagram for explaining composed videos according to an exemplary embodiment of the present invention.

FIG. 2 shows, by way of example, generating of a plurality of composed videos 211 to 214 based on an original video 201. The original video 210 may be a real video actually photographed or an animation or a virtual video using computer graphics, or the like. The original video 201 is analyzed as a position and a size of motion objects configuring the original video 201 and each event, background, and color (for example, color of clothes or hair, or the like, worn by object or human) of motions configuring the original video 201. The composed videos 211 to 214 are generated by recombining or processing the analysis results.

The original video 201 of FIG. 2 is a real video photographing shaking hands of human and the composed videos 211 to 214 show a video generated by recombining each event of motions configuring the original video 201 and pasting them to the backgrounds different from the original video 210 and changing a color of wearing clothes. For example, in the case of shaking hands, recombining each event of motions may be performed by changing an order of holding out hands for shaking hands (situation in which a first object first holds out hand, a second object first holds out hand, or the first and second objects simultaneously hold out their hands, for shaking hands).

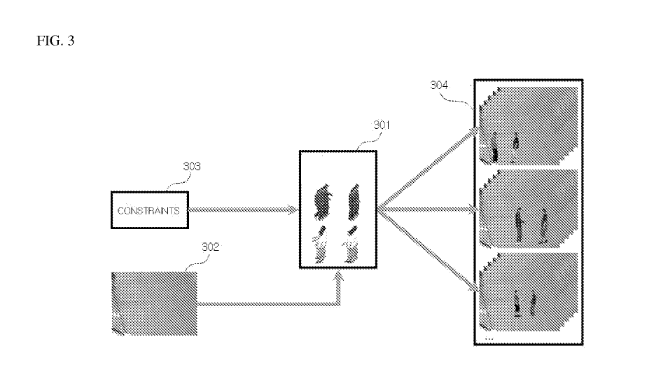

FIG. 3 is a diagram showing a process of composing videos according to an exemplary embodiment of the present invention.

Referring to FIG. 3, the motion video 301 is generated using the position and size of the motion objects analyzing the original video and each event, colors, or the like, of the motions configuring the original video. The generated video 301 is combined with a background 302.

The generated motion video subjects to a process of determining (303) whether there is temporal contrariety or spatial contrariety by structural constraints of the situations. In this case, the temporal contrariety or the spatial contrariety may include natural laws such action and reaction, causal lows, or errors such as a logical contrariety, or the like. Using the structural constraints of the situations is to remove the video having the spatio-temporal contrariety since the generated video 301 includes the spatio-temporal contrariety. For example, pushing between two persons corresponds to video having the spatio-temporal contrariety that the second object is pushed before an arm of the first object moves. The video satisfying the structural constraints of the situations is sorted into a composed video 304 capable of being used as the training videos, such that the training video set for recognizing situations is configured.

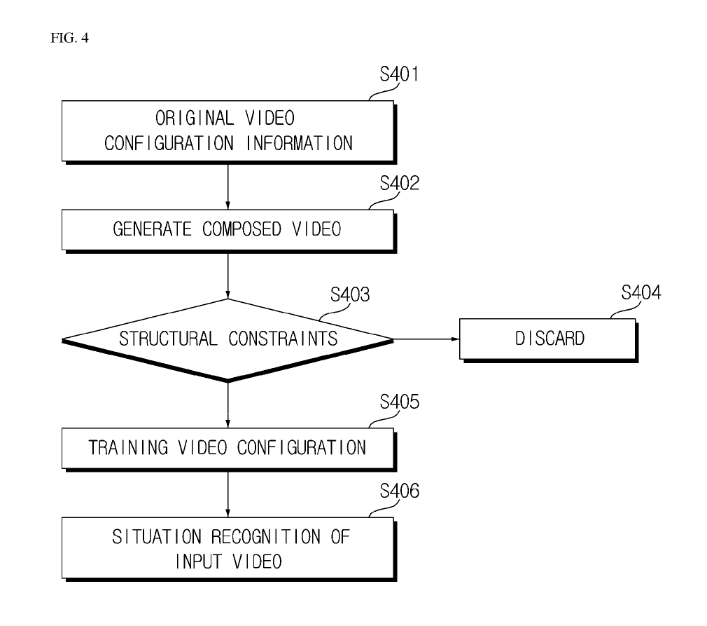

FIG. 4 is a diagram for explaining a method for generating training videos and a method of recognizing situations using composed videos according to an exemplary embodiment of the present invention.

Referring to FIG. 4, the method for generating training videos using composed videos according to the exemplary embodiment of the present invention includes generating (S402) the composed videos based on the configuration information S401) of the original video, selecting (S403) the composed videos satisfying the structural constraints of the situations among the generated composed videos, and configuring the training videos including the selected composed videos.

The generating (S402) of the composed video may generate the composed videos using the combination of the configuration information. The combination of the configuration information may include ones obtained by recombining at least one information among the configuration information, which is the analyzed results, using the configuration information, which is a result of analyzing the original video, or by combining the configuration information of components of a separate video from the configuration information which is the analyzed results. For example, the composed videos may be generated by replacing the background of the composed video with the separate background video. The description of the configuration information is applied to all the configuration information of components of the separate video and the configuration information of the original video. Hereinafter, the configuration information of the original video will be described so as to avoid the repetition of the description.

The configuration information of the original video may include the background information of the original video, the foreground information representing the motions of the objects included in the original video, and the temporal length information of the original video. The background information may be information relating to the background for the motions of the objects and the foreground information may be information relating to the relatively moving objects for the background.

The foreground information may include the spatial position information and the spatial proportion information on the motion center of the object in the original video and the event information on the event configuring motions. In this case, the event represents a unit on which the motion of the objects are subdivided and divided in the original video and may include a unit of meaning activity. For example, in the case of the “pushing” activity, when the first object pushes the second object by hand and the second object is pushed, the motions of the objects may be subdivided by being divided into the motion event where the first object holds out the hand to the second object, the motion event where the second object is pushed by the hand of the first object, and the motion event where the first object returns the hand to an original state.

The event information may include foreground sequence information during the event, identification information on objects in the event, event spatial information specifying a spatial position of the event, and event temporal information on the event. The foreground sequence may include a consecutive frame of the video configuring the event. The identification information may include each serial number information on the object of the motion represented in the video.

The event spatial information may be information that normalizes a boundary area relatively represented for the spatial position information on the motion center of the object in the original video and specifying the spatial position of the event and the event temporal information may be information that normalizes an interval and duration of the event for the temporal length information of the original video.

The generating (S402) of the composed video, which is generated using the configuration information of the original video, may spatially convert the event according to the spatial position information on the motion center of the object in the original video, convert the size according to the spatial proportion information, and generate the composed video according to the temporal length information, based on the event spatial information and the event temporal information. The generating (S402) of the composed video may include the recomposed video by recombining the configuration information of the composed video generated while satisfying the structural constraints to be described below.

The structural constraints in the selecting (S403) of the composed video may include a reference on whether there is the temporal or spatial contrariety of the motion. The structural constraints represent the conditions for discarding the composed video represented by the abnormal situation structure. When the composed video does not satisfy the structural constraints, the composed video is discarded (S404). When the composed video satisfies the structural constraints, the composed video serves as the training video.

The structural constraints may be preset information and may be set as the conditions of the decision boundary empirically obtained through the repetition of the test for several videos (including the composed video).

Whether there is the temporal contrariety may be set based on the temporal length information and the event temporal information. For example, in the case of the “pushing” activity, when the first object pushes the second object by hand and the second object is pushed, the motions of the objects may be subdivided by being divided into the motion event where the first object holds out the hand toward the second object, the motion event where the second object is pushed by the hand of the first object, and the motion event where the first object returns the hand to an original state. In this case, when the composed video is generated by the combination of the three motion events that are simultaneously started, the temporal length of the composed video becomes the event having the longest temporal length among the three motion events, which is shorter than the temporal length of the original video, such that the temporal contrariety occurs.

Whether there is the spatial contrariety may be set based on the event spatial information. For example, when the composed video is combined in the form in which the hand of the first object performing pushing operation does not reach the area of the second object in the above-mentioned “pushing” activity, the situation in which the second object is pushed even though the first object holds out his hand to the air is directed, which corresponds to the spatial contrariety.

The composed video satisfying the structural constraints is configured of the training videos (S405). The configured training video may include the original video and may also include the composed videos recomposed by using the video generated by combining the configuration information of the composed video and satisfying the structural constraints.

The method for recognizing situations using composed videos according to the exemplary embodiment of the present invention recognizes the situation of the input video to be recognized by using the training videos using the above-mentioned composed video. The method includes generating (S402) the composed video based on the configuration information (S401) of the original video, selecting (S403) the composed video satisfying the structural constraints of the situation among the generated composed videos, configuring (S404) the training video including the selected composed videos, and recognizing (S405) the situation of the recognized object video based on the training video.

The method for recognizing situations using composed videos according to the exemplary embodiment of the present invention may be used to recognize the situations for the human activity and the motion of the object and may also be applied to the usage of the monitoring/security/surveillance of the video collected from the video collection apparatus.

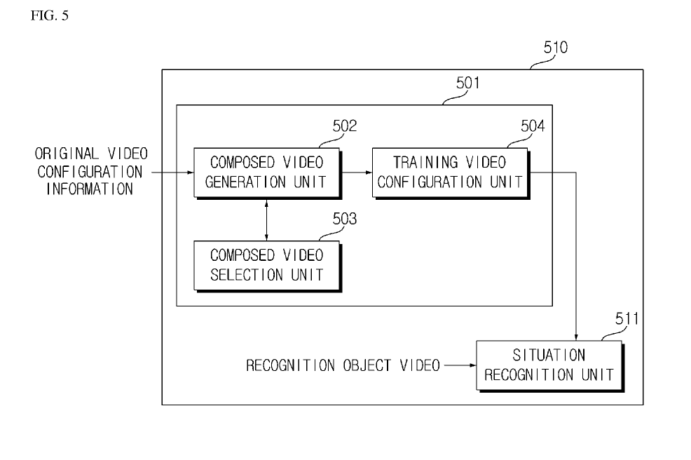

FIG. 5 is a diagram for explaining an apparatus for generating training videos using composed videos and an apparatus for recognizing situations using composed videos according to an exemplary embodiment of the present invention.

Referring to FIG. 5, an apparatus 501 for generating training videos using composed videos includes a composed video generation unit 502 that generates the composed videos based on the configuration information of the original video, a composed video selection unit 503 that selects the composed video satisfying the structural constraints of the situations among the generated composed videos, and a training video configuration unit 504 configuring the training videos including the selected composed videos. The composed video generation unit 502 may generate the composed video using the combination of the configuration information.

The configuration information may include the background information of the original video, the foreground information representing the motion of the object included in the original video, and the temporal length information of the original video. The foreground information may include the spatial position information on the motion center of the object in the original video, the spatial proportion information, and the event information on the event configuring the motion.

The event information may include foreground sequence information during the event, identification information on the objects in the event, event spatial information specifying the spatial position of the event, and event temporal information on the event. The event spatial information may be information that normalizes a boundary area relatively represented for the spatial position information and specifying the spatial position of the event and the event temporal information may be information that normalizes an interval and duration of the event for the temporal length information.

The composed video generation unit 502 may spatially convert the event according to the spatial position information, convert the size according to the spatial proportion information, and generate the composed video according to the temporal length information, based on the event spatial information and the event tie information.

The structural constraints may include the reference on whether there is the temporal or spatial contrariety of the motion. Whether there is the temporal contrariety may be set based on the temporal length information and the event temporal information.

An apparatus 510 for recognizing situations using composed videos according to the exemplary embodiment of the present invention includes a training video generation apparatus 501 using the above-mentioned composed video and includes a composed video generation unit 502 generating the composed vide based on the configuration information of the original video, a composed video selection unit 503 selecting the composed video satisfying the structural constraints of the situations among the generated composed videos, a training video configuration unit 504 configuring the training videos including the selected composed videos, and a situation recognition unit 511 recognizing the situation of the recognition object video based on the training video.

The detailed description of the apparatus for generating training videos using composed videos and the apparatus for recognizing situations using composed videos according to the exemplary embodiment of the present invention overlaps the method for generating training videos using the above-mentioned composed videos and the method for recognizing situations using the composed videos and therefore, the detailed description thereof will be omitted.

### Detailed Exemplary Embodiment

Hereinafter, a detailed exemplary embodiment of recognizing human activity will be described by way of example.

1. Configuration Information of Video

The original video photographing the human activity is analyzed as a background and a foreground. The foreground, which represents the motion of the object included in the original video, may be configured of the plurality of events. The foreground is again subdivided into each event and is analyzed. The composed video is generated by combining the analyzed foreground or event and pasting it to the background. In this configuration, the background does not represent only the background of the original video and may include the separate background for representing the environment different from the original video. As a result, the original video is divided into the important motions into the plurality of configuration information when representing the situations, and is combined using the divided configuration information, and generates the composed video by pasting it to the background. For example, the composed video may be generated by combining a bounding box representing whether the event video is spatially pasted to which place and a time interval (for example, starting time and ending time) representing which frame is pasted to the video, for each event according to the spatio-temporal area. Various types of composed videos may be generated by variously combining the configuration information. Hereinafter, the configuration information of the video represented in the exemplary embodiment of the present invention will be described in detail. Herein, the configuration information may have the configuration information of the original video and the meaning of the configuration information for generating the composed video.

The configuration information of the video V may be largely configured by three elements.

V=(b,G,S) [Equation 1]

Herein, b is the background information of the video V or the image, G includes the spatial position information c on the motion center of the object and the information (G=(c, d, o)) on the spatial proportional information d and the temporal length information o of the video V, and S represents the event information (sᵢ, S={s₁, s₂, . . . , s_{|S|}}, where Si means i-th event information) on the event configuring the motion.

Each event information sᵢ represents the foreground sequence information eᵢ (eᵢ=eᵢ⁰eᵢ¹ . . . eᵢⁿ^{ᵢ}, where nᵢ is a length of the foreground video) during each event, identification information aᵢ on the object in each event, event spatial information rᵢ (rᵢ=rᵢ^{l},rᵢ^{r},rᵢ^{h},rᵢ^{w}), where each means the information on left, right, height, and width in order) specifying the spatial position of each event), and the event temporal information tᵢ, (tᵢ=(tᵢ^{dur},tᵢ^{loc}), where each means an interval and duration of the event in order) on each event.

The event spatial information rᵢ may be information that is relatively represented for the spatial position information c and normalizes a bounding box specifying the spatial position of the event and the event temporal information tᵢ may be information that normalizes the interval and duration of the event for the temporal length information o. In this case,

$${t}_{i}^{loc} = \frac{{start}_{i} + {end}_{i}}{2 o} and {t}_{i}^{dur} = \frac{{end}_{i} - {start}_{i}}{o}$$

(where is a starting time of an i-th event and endᵢ is an ending time of the i-th event. Therefore, the actual duration of the event in the video may be represented by a product of tᵢ^{dur} and o.

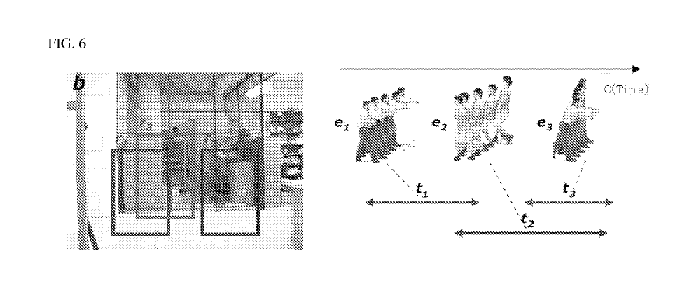

FIG. 6 is a diagram for explaining an example of analyzing videos (original video) for “pushing”.

Referring to FIG. 6, the “pushing” video is configured of three event information e₁, e₂, e₃ and is analyzed by the event spatial information r₁, r₂, r₃ and the event temporal information t₁, t₂, t₃ corresponding thereto. The foreground sequence information and the temporal length information o of the video for background b as shown in the left of FIG. 6 and each event as shown in the right of FIG. 6 are analyzed.

2. Generation of Composed Video

The composed video is generated using the above-mentioned configuration information of the video. For example, each event eᵢ is independently pasted to the spatio-temporal area rᵢ, tᵢ of the background, thereby generating the video having various activity structure.

Describing in detail, the composed video spatially may convert the event according to the spatial position information c, and convert the size according to the spatial proportion information d, and may be generated by being pasted to the background b according to the temporal length information o, based on the event spatial information rᵢ and the event temporal information tᵢ.

The spatial bounding box boxᵢ specifying the spatial position of the event may be calculated by [Equation 1]. The spatial bounding area specifies the space in which the event eᵢ is pasted to the background b.

boxᵢ=drᵢ+c [Equation 2]

The event eᵢ specifies the time or duration represented in the composed video by being pasted between the frames of startᵢ and endᵢ. startᵢ and endᵢ are each calculated by Equation 3 and Equation 4.

$$\begin{matrix}{start}_{i} = ( {t}_{i}^{loc} o - \frac{{t}_{i}^{dur} o}{2} ) & [ Equation 3 ] \\ {end}_{i} = ( {t}_{i}^{loc} o + \frac{{t}_{i}^{dur} o}{2} ) & [ Equation 4 ]\end{matrix}$$

For each event eᵢ, an eᵢ^{j} frame of the event video is pasted to a k-th frame of the video to be composed. That is, for the event duration tᵢ^{dur} for all the frames k between startᵢ and endᵢ, a j-th frame of the event video is calculated in consideration of all durations.

$$j = ( \frac{( k - {start}_{i} ) {n}_{i}}{{t}_{i}^{dur} o} ) \qquad [ Equation 5 ]$$

Meanwhile, the object (or subject) of the motion is pasted to the frame between the events. Since the important event of the motion object is already analyzed as each event information, the motion object may be assumed to be in the stop state when the event is not performed. For each motion object, all the frames I that are not included in any event search the temporally closest event s_{q} by reviewing the appearance of the motion. When end_{q} is smaller than the frame 1, e_{q}ⁿ^{_{q}} is pasted to the frame 1 and otherwise, e_{q}^{o} is pasted thereto. This is based on the assumption that the appearance of the motion in the closest frame of the event is the same as the appearance of the motion of the frame 1.

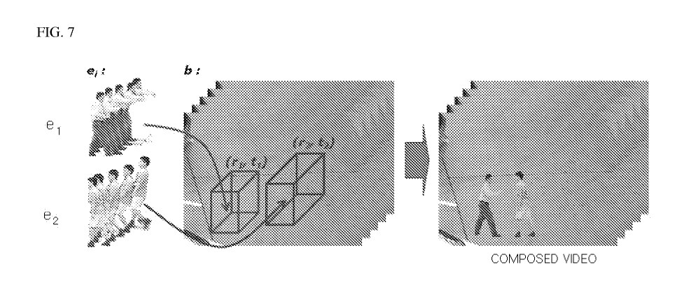

FIG. 7 is a diagram for explaining a process of generating composed videos.

FIG. 7 shows that the composed video is generated by pasting the event information eᵢ to the background b based on the event spatial information rᵢ and the event temporal information tᵢ. e₁,e₂ The composed video is generated by pasting e₁,e₂ to background b according to r₁,t₁ and r₂,t₂, respectively.

Meanwhile, various composed videos may be generated by applying various image processing methods such as color conversion or flipping to the composed video.

3. Structural Constraints for Composed Video

As described above, the video having the structural contrariety may be included in the composed videos generated using the combination of the configuration information of the video. Therefore, the video that does not satisfy the structural constraints of situations among the generated composed videos is removed.

The structural constraints may include a reference on whether there is the temporal or the spatial contrariety of the motion in the video. In this case, whether there is the temporal contrariety may be set based on the temporal length information o and the event temporal information tᵢ. That is, a vector having a length of 2|S|+1 is formed by associating the temporal length information o of the video V with the interval information of all the event temporal information tᵢ of and it is determined that the given vector x in the 2|S|+1 dimensional space is appropriate for the temporal structure.

Meanwhile, the decision boundary may be set so as to determine whether the structural constraints are satisfied. The decision boundary may improve the accuracy by an iteration algorithm. During each iteration process, the decision boundary may be reset or updated based on the sample information of the video that satisfies the existing structural constraints and the video that does not satisfy the existing structural constraints. The object xₘᵢₙ that may give the most useful information is selected from several vectors xₘ arbitrarily sampled for a proposal video structure for generating the decision boundary. The update information of the decision boundary is generated based on the selected vector xₘᵢₙ and therefore, the composed video is generated by correcting the original video.

It is determined whether the generated composed video satisfies the structural constraints and the new decision boundary is set using the composed video as the new sample information.

In the exemplary embodiment of the present invention, the method of selecting a support vector machine (SVM) is applied. If it is assumed that a hyperplane wx+a=0 (w,a are a real number) is a straight line corresponding to the decision boundary, the vector xₘᵢₙ minimizing the vector xₘ and the hyperplane distance is searched by the iteration algorithm.

$${x}_{min} = {argmin}_{{x}_{m}} \frac{{wx}_{m} + a}{‖ w ‖} \qquad [ Equation 6 ]$$

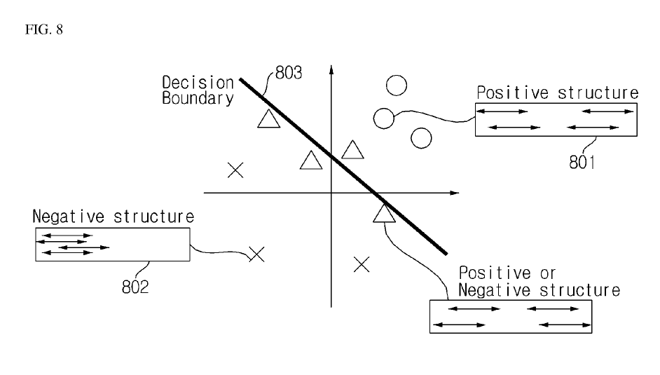

FIG. 8 is a diagram for explaining a model for setting structural constraints.

Referring to FIG. 8, a circle mark (positive structure 801) means a video satisfying the structural constraints and an (X) mark (negative structure 802) means a video that does not satisfy the structural constraints. The boundary as to whether the structural constraints are satisfied corresponds to the decision boundary 803 represented by a solid line having a negative slope. The decision boundary 803 may be set according to whether there is the above-mentioned temporal contrariety or spatial contrariety.

The case in which ones of the generated composed videos are adjacent to the decision boundary 803 to make it difficult to be uniformly determined may occur. In this case, the video is represented by a triangular shape (positive or negative structure 804). When viewing the temporal structure (represented by a box and four bidirectional arrows, each bidirectional arrow meaning each event) of the “negative structure” 802, all the events overlap each other. For example, when the video is the consecution of the event according to the temporal sequence (for example, a structure where a body is pushed after a hand is held out, as in the “pushing”), it is determined that the structure in which all the events overlaps each other does not satisfy the structural constraints.

When reviewing the temporal structure of the “positive or negative structure” 804, the temporal structure of the “positive or negative structure” 804 has a difference in only a sequence from the temporal structure of the positive structure 801 and may be difficult to be uniformly determined. In this case, in order to solve the ambiguity and more accurately determine whether the composed video adjacent to the decision boundary 803 satisfies the structural constraints, there may be a need for an additional method for generating the structural constraints.

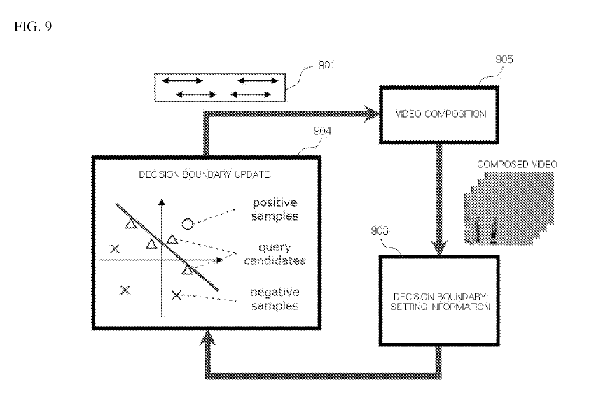

FIG. 9 shows an iteration algorithm for improving the accuracy of the decision boundary.

Referring to FIG. 9, the video 902 is composed based on the sample structure 901. The information for setting the decision boundary is generated (903) based on the generated composed video and the decision boundary is updated (904) based on the generated decision boundary setting information. The process is iteratively performed and the decision boundary may be more accurately set by the iteration performance.

The matters shown in the decision boundary update 904 of FIG. 9 is the same as a model setting the structural constraints of FIG. 8. However, a circle mark (positive structure 801) is represented by a ‘positive sample’, an (X) mark (negative structure 802) is represented by a ‘negative sample’, and a triangular mark (positive or negative structure 804) is represented by a ‘query candidates’. The iteration algorithm of the sample structure 901 is mainly selected and performed in the ‘query candidates’ positioned around the decision boundary, thereby updating the decision boundary.

4. Configuration of Training Video and Situation Recognition

The composed video satisfying the structural constraints is configured as the training video. Since the training video may be generated by various changes of the position, size, and time structure of the event and may be pasted to various types of backgrounds, the time and cost to generate the training videos may be remarkably reduced. In particular, the exemplary embodiment of the present invention may additionally generate the recomposed video based on the composed video generated from the original video, such that only a single original video may generate numerous training videos.

The generated training video is used as a training video for recognizing the situations of the recognition object video. The composed video may be generated using the background of the recognition object video as the basic information and the accuracy of recognition may be more improved by generating the composed video using the size, color, or the like, of the motion subject of the recognition object video as the additional basic information.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for generating training videos using composed videos, comprising:
generating composed videos based on configuration information of an original video;
selecting the composed videos satisfying structural constraints of situations among the generated composed videos; and
configuring the training videos including the selected composed videos.

2. The method of claim 1, wherein the generating of the composed video generates the composed videos using the combination of the configuration information.

3. The method of claim 2, wherein the configuration information includes background information of the original video, foreground information representing motions of objects included in the original video, and temporal length information of the original video.

4. The method of claim 3, wherein the foreground information includes spatial position information on a motion center of the objects, spatial proportion information, and event information on events configuring the motion in the original video.

5. The method of claim 4, wherein the event information includes foreground sequence information during the event, identification information on the objects in the event, event spatial information specifying a spatial position of the event, and event temporal information on the event.

6. The method of claim 5, wherein the event spatial information is information that normalizes a boundary area relatively represented for the spatial position information and specifying the spatial position of the event and the event temporal information is information that normalizes an interval and duration of the event for the temporal length information.

7. The method of claim 5, wherein the generating of the composed video spatially converts the event according to the spatial position information, converts the size according to the spatial proportion information and generates the composed video according to the temporal length information, based on the event spatial information and the event temporal information.

8. The method of claim 5, wherein the structural constraints includes a reference on whether there is temporal or spatial contrariety of the motion.

9. The method of claim 8, wherein whether there is the temporal contrariety is set based on the temporal length information and the event temporal information.

10. A method for recognizing situations using composed videos, comprising:
generating composed videos based on configuration information of an original video;
selecting the composed videos satisfying structural constraints of situations among the generated composed videos;
configuring the training videos including the selected composed videos; and
recognizing situations of recognition object videos based on the training videos.

11. An apparatus for generating training videos using composed videos, comprising:
a composed video generation unit that generates composed videos based on configuration information of an original video;
a composed video selection unit that selects the composed videos satisfying structural constraints of situations among the generated composed videos; and
a training video configuration unit that configures the training videos including the selected composed videos.

12. The apparatus of claim 11, wherein the composed video generation unit generates the composed videos using the combination of the configuration information.

13. The apparatus of claim 12, wherein the configuration information includes background information of the original video, foreground information representing motions of objects included in the original video, and temporal length information of the original video.

14. The apparatus of claim 13, wherein the foreground information includes spatial position information on a motion center of the objects, spatial proportion information, and event information on events configuring the motion in the original video.

15. The apparatus of claim 14, wherein the event information includes foreground sequence information during the event, identification information on the objects in the event, event spatial information specifying a spatial position of the event, and event temporal information on the event.

16. The apparatus of claim 15, wherein the event spatial information is information that normalizes a boundary area relatively represented for the spatial position information and specifying the spatial position of the event and the event temporal information is information that normalizes an interval and duration of the event for the temporal length information.

17. The apparatus of claim 15, wherein the composed video generation unit spatially converts the event according to the spatial position information, converts the size according to the spatial proportion information, and generates the composed video according to the temporal length information, based on the event spatial information and the event temporal information.

18. The apparatus of claim 15, wherein the structural constraints includes a reference on whether there is temporal or spatial contrariety of the motion.

19. The apparatus of claim 18, wherein whether there is the temporal contrariety is set based on the temporal length information and the event temporal information.

20. An apparatus for recognizing situations using composed videos, comprising:
a composed video generation unit that generates composed videos based on configuration information of an original video;
a composed video selection unit that selects the composed videos satisfying structural constraints of situations among the generated composed videos;
a training video configuration unit that configures the training videos including the selected composed videos; and
a situation recognition unit that recognizes situations of a recognition object video based on the training videos.
